(19) United States
(12) Patent Application Publication
(10) Pub. No.: US 2026/0286913 A1
(43) Pub. Date: Sep. 24, 2026

(54) CONTROLLER FOR VEHICLE ON-BOARD INTERNAL COMBUSTION ENGINE

(71) Applicant: TOYOTA JIDOSHA KABUSHIKI KAISHA, Toyota-shi (JP)

(72) Inventor: Taichi NISHIMURA, Toyota-shi (JP)

(21) Appl. No.: 19/370,750

(22) Filed: Oct. 28, 2025

(30) Foreign Application Priority Data
Mar. 18, 2025 (JP) 2025-043407

(51) Int. Cl. F02D 41/30

(52) U.S. Cl. CPC F02D 41/3082; F02D 2200/50; F02D 2200/60

(57) ABSTRACT

A controller for a vehicle on-board internal combustion engine is provided. An operation switch switches between operation and stopping of the internal combustion engine. A rain sensor detects a degree of droplet adhesion to a windshield. A fuel pump delivers fuel from the fuel tank. A seal member seals a gap between a fuel injection valve and an intake passage. Control circuitry actuates the fuel pump when a logical conjunction of the following conditions is satisfied: (i) a condition in which operation of the internal combustion engine has been stopped by manipulation of the operation switch; and (ii) a condition in which the degree of droplet adhesion detected by the rain sensor is greater than or equal to a prescribed value.

### CROSS-REFERENCE TO RELATED APPLICATIONS

This application is based upon and claims the benefit of priority from Japanese Patent Application No. 2025-043407, filed on Mar. 18, 2025, the entire contents of which are incorporated herein by reference.

### BACKGROUND

### 1. Field

The present disclosure relates to a controller for a vehicle on-board internal combustion engine.

### 2. Description of Related Art

It is common for vehicles such as automobiles to be equipped with an internal combustion engine as a drive source.

Fuel from a fuel tank is delivered by a fuel pump. The fuel is delivered through a fuel supply passage and injected from a fuel injection valve into a fuel receiving portion, such as an intake passage of the vehicle on-board internal combustion engine. A seal member seals a gap between the fuel injection valve and the fuel receiving portion.

For example, JP2009-91963A discloses a relief valve provided in a fuel supply passage of a vehicle on-board internal combustion engine. When the engine operation is stopped, the relief valve is opened so that the fuel pressure in the fuel supply passage can be reduced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for a vehicle on-board internal combustion engine is provided. The controller includes control circuitry. The vehicle on-board internal combustion engine is an internal combustion engine mounted on a vehicle. The vehicle includes a fuel tank, a fuel supply device, an operation switch that switches between operation and stopping of the internal combustion engine, and a rain sensor that detects a degree of droplet adhesion to a windshield. The fuel supply device includes an electric fuel pump that delivers fuel from the fuel tank, a fuel supply passage through which the fuel delivered by the fuel pump flows, a fuel injection valve, and a seal member. The fuel injection valve includes a first end connected to the fuel supply passage and a second end connected to an intake passage of the internal combustion engine and provided with an injection hole. The fuel injection valve injects fuel in the fuel supply passage from the injection hole into the intake passage. The seal member seals a gap between the fuel injection valve and the intake passage. The seal member is provided in a state of being sandwiched between the fuel injection valve and the intake passage in an injection direction of the fuel injection valve. The control circuitry is configured to actuate the fuel pump when a logical conjunction of following conditions is satisfied: (i) a condition in which operation of the internal combustion engine has been stopped by manipulation of the operation switch; and (ii) a condition in which the degree of droplet adhesion detected by the rain sensor is greater than or equal to a prescribed value.

This configuration reliably suppresses water ingress into the intake passage of the internal combustion engine.

The fuel pressure in the fuel supply passage acts as a pressing force urging the fuel injection valve in a direction away from the fuel supply passage. In other words, the fuel pressure in the fuel supply passage presses the fuel injection valve in a direction toward the fuel receiving portion. In the above-described fuel injection device, the pressing force increases as the fuel pressure in the fuel supply passage increases. Therefore, the surface pressure of the sealing surface of the seal member provided between the fuel injection valve and the fuel receiving portion increases. Conversely, when the fuel pressure in the fuel supply passage decreases, the surface pressure of the sealing surface of the seal member also decreases, which may reduce the sealing performance of the seal member.

When the vehicle is stopped, rainwater or wash water may enter the engine compartment. Water that has entered the engine compartment may, in some cases, reach the location where the sealing member is disposed. If the fuel pressure in the fuel supply passage has been reduced, the sealing performance of the seal member may be diminished. The connection portion between the fuel receiving portion and the fuel injection valve is where the seal member is disposed. Accordingly, water may intrude into the internal combustion engine, specifically into the fuel receiving portion, through the connection portion between the fuel receiving portion and the fuel injection valve. Water ingress into the internal combustion engine is undesirable. The above-described configuration suppresses this potential issue.

Other features and aspects will be apparent from the following detailed description, the drawings, and the claims.

### BRIEF DESCRIPTION OF THE DRAWINGS

FIG. 1 is a schematic diagram showing a configuration of a vehicle equipped with a controller for a vehicle on-board internal combustion engine according to a first embodiment.

FIG. 2 is a schematic diagram showing a configuration of a fuel supply device of an internal combustion engine according to the first embodiment.

FIG. 3 is a cross-sectional side view including a fuel injection valve according to the first embodiment.

FIG. 4 is a flowchart showing pump control at engine shutdown according to the first embodiment.

FIG. 5 is a flowchart showing pump control at engine shutdown according to a second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

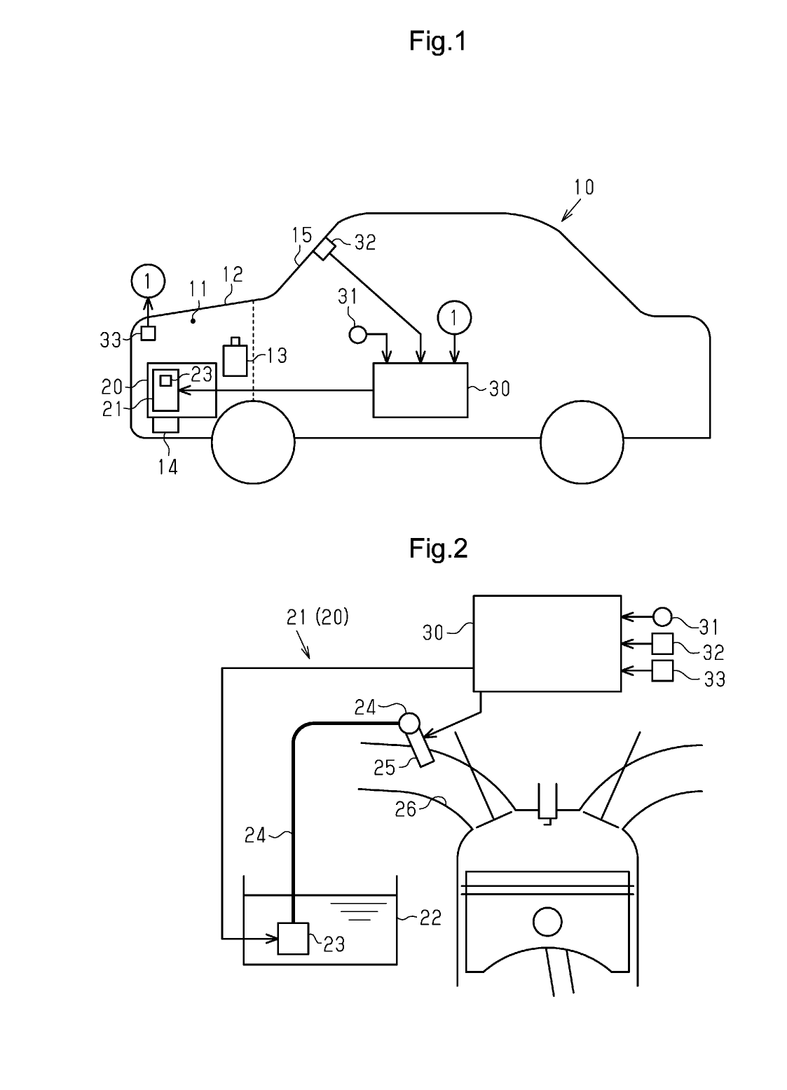

FIGS. 1-4 illustrate a controller for a vehicle on-board internal combustion engine according to a first embodiment.

### Vehicle 10

As shown in FIG. 1, an internal combustion engine 20 is mounted on a vehicle 10 as a traveling drive source. The vehicle 10 is equipped with an internal combustion engine 20 as a drive source. The internal combustion engine 20 includes a fuel supply device 21. The vehicle 10 includes an engine compartment 11 and an engine compartment hood 12. The internal combustion engine 20 is provided in the engine compartment 11. The engine compartment hood 12 opens and closes an upper opening of the engine compartment 11. The vehicle 10 includes a storage battery 13 and an alternator 14. The storage battery 13 is a power source of the in-vehicle device. The alternator 14 is an engine-driven generator. During operation of the internal combustion engine 20, the storage battery 13 is charged with electric power generated by the alternator 14.

### Fuel Supply Device 21

As shown in FIG. 2, a fuel supply device 21 of the internal combustion engine 20 includes a fuel tank 22, a fuel pump 23, a fuel supply passage 24, and a fuel injection valve 25.

The fuel tank 22 stores fuel to be supplied to the internal combustion engine 20. The fuel pump 23 delivers the fuel in the fuel tank 22. The fuel pump 23 is electrically driven. The fuel that has been delivered by the fuel pump 23 is introduced into the fuel supply passage 24 and flows through the fuel supply passage 24. A first end 25A of the fuel injection valve 25 is connected to the fuel supply passage 24. A second end 25B of the fuel injection valve 25 is connected to an intake passage 26 of the internal combustion engine 20. The fuel injection valve 25 is driven to open to inject the fuel in the fuel supply passage 24 from the injection hole 25C in the second end 25B into the intake passage 26.

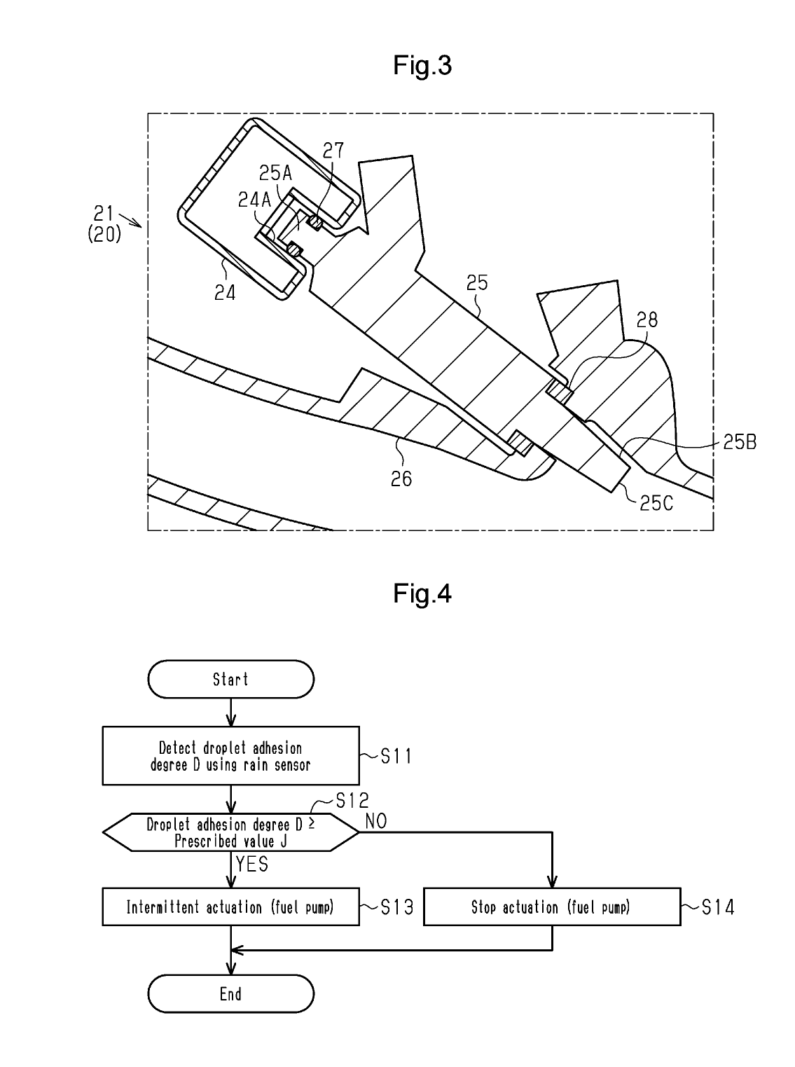

As shown in FIG. 3, the fuel supply device 21 includes a first seal member 27 and a second seal member 28.

The first seal member 27 is provided at a connection portion between the first end 25A of the fuel injection valve 25 and the fuel supply passage 24. The first seal member 27 has an annular shape. The first seal member 27 is provided in a state of being sandwiched between the outer peripheral surface of the first end 25A of the fuel injection valve 25 and the inner surface of the attachment hole 24A of the fuel supply passage 24. The first seal member 27 seals a clearance between the fuel injection valve 25 and the fuel supply passage 24 at a connection portion between the first end 25A of the fuel injection valve 25 and the fuel supply passage 24.

The second seal member 28 is provided at a connection portion between the second end 25B of the fuel injection valve 25 and the intake passage 26. The second seal member 28 has an annular shape. The second seal member 28 is interposed between the fuel injection valve 25 and the intake passage 26 in the injection direction of the fuel injection valve 25. The second seal member 28 seals a clearance between the fuel injection valve 25 and the intake passage 26 at a connection portion between the second end 25B of the fuel injection valve 25 and the intake passage 26.

### Electronic Control Unit 30

As shown in FIGS. 1 and 2, the vehicle 10 includes an electronic control unit 30 as a control unit. The electronic control unit 30 is control circuitry including a CPU and a memory including a ROM, a RAM, and the like. The CPU constitutes a processor or a processing circuit. The ROM and RAM may constitute non-transitory computer-readable storage media. The electronic control unit 30 executes various kinds of control relating to the operation of the internal combustion engine 20, such as drive control of the fuel injection valve 25 and operation control of the fuel pump 23, by the CPU executing a program stored in the memory.

The vehicle 10 is provided with an operation switch 31, a rain sensor 32, and a hood switch 33. The operation switch 31 is a switch that is operated by an occupant when the operation of the internal combustion engine 20 is started or stopped. The rain sensor 32 detects a droplet adhesion degree D as a degree of droplet adhesion to the windshield 15 of the vehicle 10. The droplet adhesion degree D detected by the rain sensor 32 is a value corresponding to the amount of water droplets adhering to the windshield 15 per unit area. The hood switch 33 detects whether the engine compartment hood 12 of the vehicle 10 is open or closed. The operation switch 31, the rain sensor 32, and the hood switch 33 are connected to the electronic control unit 30.

In the present embodiment, characteristic control is executed in an engine operation stop period in which the operation of the internal combustion engine 20 is stopped by the operation of the operation switch 31. In the present embodiment, the electronic control unit 30 is configured so as to be able to execute operation control of the fuel pump 23 in the engine operation stop period. Specifically, during the engine operation stop period, electric power from the storage battery 13 is supplied to the operation switch 31, the rain sensor 32, and the electronic control unit 30. In the engine operation stop period, the electronic control unit 30 performs various calculations based on the operation state of the operation switch 31 and the detection signal of the rain sensor 32, and executes the operation control of the fuel pump 23 based on the calculation result.

As shown in FIG. 3, in the fuel supply device 21, the fuel injection valve 25 is provided between the fuel supply passage 24 and the intake passage 26 via a first seal member 27 and a second seal member 28. The fuel pressure in the fuel supply passage 24 acts as a pressing force that presses the fuel injection valve 25 in a direction away from the fuel supply passage 24, that is, in a direction toward the intake passage 26. Therefore, in the fuel supply device 21, if the fuel pressure of the fuel supply passage 24 becomes lower, the pressing force becomes smaller, so the surface pressure of the sealing surface of the second seal member 28 provided between the fuel injection valve 25 and the intake passage 26 may also become lower. As a result, the sealing performance of the second seal member 28 may be reduced.

Since the fuel pump 23 operates during the operation of the internal combustion engine 20, the fuel pressure in the fuel supply passage 24 is maintained at an appropriately high pressure. However, when the operation of the fuel pump 23 is stopped in accordance with the stop of the operation of the internal combustion engine 20, the fuel pressure in the fuel supply passage 24 gradually decreases thereafter. As the fuel pressure decreases, the sealing performance of the second seal member 28 may decrease. If water reaches the connection portion between the fuel injection valve 25 and the intake passage 26 due to rainfall or car washing in a state where the sealing performance of the second seal member 28 is low, water may enter the intake passage 26 through the connection portion between the fuel injection valve 25 and the intake passage 26.

Therefore, in the present embodiment, when the operation of the internal combustion engine 20 is stopped by the operation of the operation switch 31, the fuel pump 23 is actuated in a case in which there is a concern that water will reach the portion where the second seal member 28 is disposed.

By actuating the fuel pump 23, the fuel pressure in the fuel supply passage 24 can be appropriately increased. Therefore, high sealing performance by the second seal member 28 is obtained. Even if water reaches the connection portion between the fuel injection valve 25 and the intake passage 26, the second seal member 28 suppresses water ingress into the intake passage 26. A connection portion between the fuel injection valve 25 and the intake passage 26 is a portion where the second seal member 28 is disposed.

### Pump Control at Engine Shutdown

Hereinafter, the pump control at eigne shutdown will be described in detail. The pump control at engine shutdown is operation control of the fuel pump 23 that is executed when the operation of the internal combustion engine 20 is stopped by the operation of the operation switch 31.

FIG. 4 shows an execution procedure of the pump control at engine shutdown. The series of processes shown in the flowchart of FIG. 4 are processes executed by the electronic control unit 30 at specified intervals on condition that the operation of the internal combustion engine 20 has been stopped by manipulation of the operation switch 31.

As shown in FIG. 4, in this process, the rain sensor 32 detects the droplet adhesion degree D of moisture droplets on the windshield 15 (step S11), and it is determined whether the droplet adhesion degree D is greater than or equal to a prescribed value J (step S12).

If the droplet adhesion degree D is greater than or equal to the prescribed value J (step S12: YES), the fuel pump 23 is actuated (step S13). When the droplet adhesion degree D is greater than or equal to the prescribed value J, the amount of water droplets adhering to the windshield 15 is relatively large. Therefore, water splashed on the vehicle 10 may enter the engine compartment 11 and reach the location where the second seal member 28 is disposed. In response to this, the fuel pump 23 is actuated.

In the process of step S13, the fuel pump 23 is intermittently actuated. Specifically, a first control for actuating the fuel pump 23 and a second control for stopping the operation of the fuel pump 23 are alternately executed. The first control continuously actuates the fuel pump 23 for a first specified period (for example, several seconds) determined in advance. The second control continuously stops the fuel pump 23 for a second specified period (for example, one hour) determined in advance.

In this process, the fuel pump 23 is actuated when a logical conjunction of the following condition is satisfied: (i) a condition in which the operation of the internal combustion engine 20 has been stopped by manipulation of the operation switch 31; and (ii) a condition in which the droplet adhesion degree D detected by the rain sensor 32 is greater than or equal to the prescribed value J.

On the other hand, when the droplet adhesion degree D detected by the rain sensor 32 is less than the prescribed value J (step S12: NO), the operation of the fuel pump 23 is stopped (step S14).

### Operation and Advantages of the First Embodiment

(1-1) The electronic control unit 30 actuates the fuel pump 23 when the logical conjunction of the following conditions is satisfied: (i) the condition in which the operation of the internal combustion engine 20 has been stopped by manipulation of the operation switch 31; and (ii) the condition in which the droplet adhesion degree D detected by the rain sensor 32 is greater than or equal to the prescribed value J.

According to the above configuration, based on the operation state of the operation switch 31 and the output signal of the rain sensor 32, in a state where the operation of the internal combustion engine 20 is stopped, it is possible to determine that the vehicle 10 is in a situation where water is likely to splash on the vehicle 10 due to rainfall or car washing. As a result, it is possible to determine that a situation exists in which ingress of water into the intake passage 26 of the internal combustion engine 20 may occur when the sealing performance of the second seal member 28 is low.

By actuating the fuel pump 23, the fuel pressure in the fuel supply passage 24 is increased. Therefore, it is possible to increase the pressing force for pressing the fuel injection valve 25 in the direction approaching the intake passage 26. This makes it possible to increase the surface pressure of the sealing surface of the second seal member 28. That is, high sealing performance by the second seal member 28 is obtained. Even if water reaches the connection portion between the fuel injection valve 25 and the intake passage 26, the second seal member 28 disposed at the connection portion can suitably suppress water ingress into the intake passage 26 of the internal combustion engine 20. Therefore, it is possible to suppress a decrease in the performance of the internal combustion engine 20 due to water ingress into the intake passage 26.

(1-2) The electronic control unit 30 intermittently actuates the fuel pump 23 when the logical conjunction is satisfied.

According to the above-described configuration, when the operation of the internal combustion engine 20 is stopped, the fuel pump 23 can be actuated so as to obtain an appropriate sealing performance by the second seal member 28 while suppressing the power consumption of the electric fuel pump 23. Therefore, the fuel pump 23 can be actuated for a longer period of time by the stop time of the fuel pump 23, for example, as compared with the case in which the fuel pump 23 is continuously actuated. Therefore, water ingress into the intake passage 26 can be suppressed.

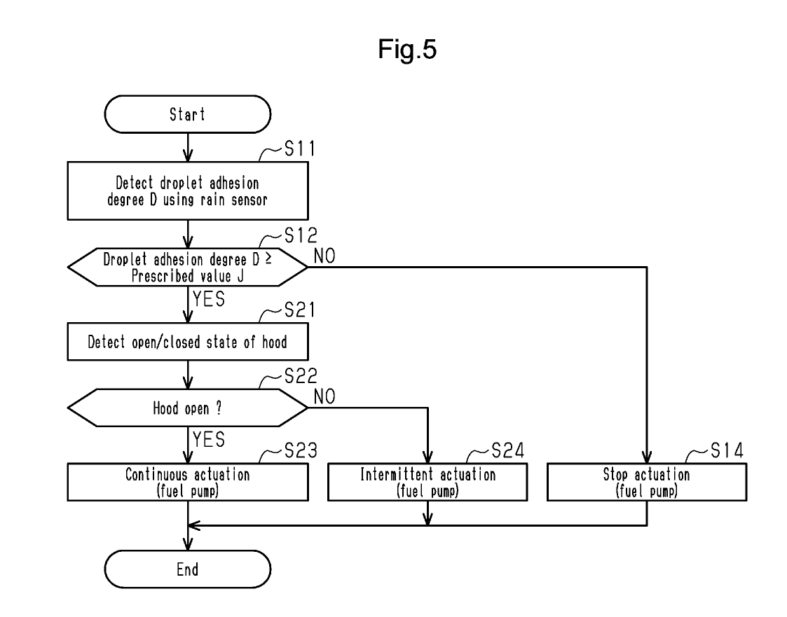

Referring to FIG. 5, a second embodiment of a controller for a vehicle on-board internal combustion engine will be described focusing on differences from the first embodiment.

The second embodiment of FIG. 5 differs from the first embodiment of FIG. 4 in the manner in which the pump control at engine shutdown is executed.

The pump control at engine shutdown according to the second embodiment will be described with reference to FIG. 5.

FIG. 5 shows an execution procedure of the pump control at engine shutdown according to the second embodiment. The series of processes shown in the flowchart of FIG. 5 are processes executed by the electronic control unit 30 at specified intervals on condition that the operation of the internal combustion engine 20 has bee stopped by manipulation of the operation switch 31. The same processes as those shown in FIG. 4 are denoted by the same reference numerals in FIG. 5.

As shown in FIG. 5, in this process, the rain sensor 32 detects the droplet adhesion degree D of moisture droplets on the windshield 15 (step S11), and it is determined whether the droplet adhesion degree D is greater than or equal to a prescribed value J (step S12).

If the droplet adhesion degree D is greater than or equal to the prescribed value J (step S12: YES), the hood switch 33 detects the open/closed state of the engine compartment hood 12 (step S21), and it is determined whether the engine compartment hood 12 is open (step S22).

When the engine compartment hood 12 is opened (step S22: YES), the fuel pump 23 is continuously actuated (step S23). In the process of step S23, the fuel pump 23 is continuously actuated without being stopped.

When the engine compartment hood 12 is open, the amount of water droplets adhering to the windshield 15 may be large. Therefore, water splashed on the vehicle 10 may enter the engine compartment 11 and reach the portion where the second seal member 28 is disposed. In response to this, the fuel pump 23 is actuated. When the engine compartment hood 12 is opened, there is a possibility that water is directly splashed on the internal combustion engine 20. Therefore, water is likely to reach a portion where the second seal member 28 is disposed. On the other hand, the fuel pump 23 is continuously actuated.

In this process, the fuel pump 23 is continuously actuated when the engine compartment hood 12 is open in a case in which the logical conjunction of the following conditions is satisfied: (i) the condition in which the operation of the internal combustion engine 20 has been stopped by manipulation of the operation switch 31; and (ii) the condition in which the droplet adhesion degree D is greater than or equal to the prescribed value J.

On the other hand, when the engine compartment hood 12 is in the closed state (step S22: NO), the fuel pump 23 is intermittently actuated (step S24). In the process of step S24, a first control for actuating the fuel pump 23 and a second control for stopping the fuel pump 23 are alternately executed. Each first control continuously actuates the fuel pump 23 for a first specified period (for example, several seconds) determined in advance. Each of the second controls continuously stops the fuel pump 23 for a second specified period (for example, one hour) determined in advance.

When the droplet adhesion degree D is greater than or equal to the prescribed value J, the amount of water droplets adhering to the windshield 15 is relatively large. Therefore, water splashed on the vehicle 10 may enter the engine compartment 11 and reach the location where the second seal member 28 is disposed. In response to this, the fuel pump 23 is actuated. However, since the engine compartment hood 12 is closed, the internal combustion engine 20 is not directly exposed to water. Accordingly, compared to a case in which the engine compartment hood 12 is open, water is less likely to reach the location where the second seal member 28 is disposed. The fuel pump 23 is intermittently actuated.

In this process, the fuel pump 23 is intermittently actuated when the engine compartment hood 12 is closed in a case in which the logical conjunction of the following conditions is satisfied: (i) the condition in which the operation of the internal combustion engine 20 has been stopped by manipulation of the operation switch 31; and (ii) the condition in which the droplet adhesion degree D is greater than or equal to the prescribed value J.

When the droplet adhesion degree D detected by the rain sensor 32 is less than the prescribed value J (step S12: NO), the operation of the fuel pump 23 is stopped (step S14).

### Operation and Advantages of the Second Embodiment

According to the second embodiment of FIG. 5, in addition to the operation and advantage of (1-1) described above, the following operation and advantage can be obtained.

(2-1) The electronic control unit 30 intermittently actuates the fuel pump 23 when the engine compartment hood 12 is closed in a case in which the logical conjunction is satisfied. The electronic control unit 30 continuously actuates the fuel pump 23 when the engine compartment hood 12 is opened in the case in which the logical conjunction is satisfied.

According to the above configuration, when the engine compartment hood 12 is closed, the internal combustion engine 20 is not directly exposed to water. In this case, it is difficult for water to reach the portion where the second seal member 28 is disposed. Thus, the fuel pump 23 is intermittently operated. In this case, the fuel pump 23 can be actuated so as to obtain an appropriate sealing performance by the second seal member 28 while suppressing the power consumption of the electric fuel pump 23. On the other hand, when the engine compartment hood 12 is open, the internal combustion engine 20 may be directly exposed to water. Therefore, water easily reaches the portion where the second seal member 28 is disposed. In this case, the fuel pump 23 is continuously actuated. Therefore, the sealing performance of the second seal member 28 can be maintained at a high level at all times. As a result, the entry of water into the intake passage 26 can be suitably suppressed.

### Modifications

The above-described embodiments may be modified as follows. The above-described embodiments and the following modifications can be implemented in combination with each other as long as there is no technical contradiction.

In the first embodiment, the hood switch 33 can be omitted.

In the first embodiment, when the logical conjunction condition is satisfied, the fuel pump 23 may be continuously actuated instead of being intermittently actuated.

In each embodiment, the length of the first specified period and the length of the second specified period can be arbitrarily set. In short, the length of the first specified period and the length of the second specified period may be set such that appropriate sealing performance by the second seal member 28 is obtained while suppressing the power consumption of the fuel pump 23.

In the second embodiment of FIG. 5, when the engine compartment hood 12 is opened in the case in which the logical conjunction is satisfied, the fuel pump 23 may be intermittently actuated instead of being continuously actuated. In this case, the first specified period and the second specified period are preferably set such that the ratio of the period during which the fuel pump 23 is actually operated to the entire period during which the fuel pump 23 is intermittently actuated is larger when the engine compartment hood 12 is in the open state than when the engine compartment hood 12 is in the closed state. According to the above-described configuration, the sealing performance of the second seal member 28 when the engine compartment hood 12 is open can be made higher than the sealing performance of the second seal member 28 when the engine compartment hood 12 is closed.

When the engine compartment hood 12 is opened in the operation stop period in which the operation of the internal combustion engine 20 is stopped by the operation of the operation switch 31, the following operation may be performed. For example, the fuel pump 23 may be actuated regardless of the droplet adhesion degree D detected by the rain sensor 32.

According to the above configuration, when the engine compartment hood 12 is opened, the fuel pump 23 can be actuated. When the engine compartment hood 12 is open, there is a possibility that the internal combustion engine 20 is directly exposed to water. Therefore, water is likely to reach the portion where the second seal member 28 is disposed. By actuating the fuel pump 23, the sealing performance of the second seal member 28 can always be maintained in a high state. Therefore, it is possible to suitably suppress entry of water into the intake passage 26.

The controller for a vehicle on-board internal combustion engine according to each embodiment can also be applied to a hybrid vehicle including the internal combustion engine 20 and a motor as traveling drive sources. In the hybrid vehicle, the storage battery 13 having a large capacity can be mounted as compared with the vehicle 10 in which only the internal combustion engine 20 is mounted as the driving source. According to the above-described configuration, in the hybrid vehicle, the fuel pump 23 can be actuated by power supply from the large-capacity storage battery 13 without worrying about power shortage.

The controller of the internal combustion engine 20 is not limited to a device that includes a CPU and a memory and executes software processing. For example, the controller of the internal combustion engine 20 may include a dedicated hardware circuit such as an ASIC that performs hardware processing of at least a part of the software processing in the above embodiment. That is, the controller of the internal combustion engine 20 may include a processing circuit having any one of the following configurations (a) Processing circuitry including one or more processors that execute all of the above-described processes according to programs and one or more program storage devices such as ROMs that store the programs. (b) Processing circuitry including one or more processors and one or more program storage devices that execute part of the above-described processes according to the programs and one or more dedicated hardware circuits that execute the remaining processes. (c) Processing circuitry including one or more dedicated hardware circuits that execute all of the above-described processes. The program storage devices, which are computer-readable media, include any type of medium that is accessible by a general-purpose computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle on-board internal combustion engine, the controller comprising control circuitry, wherein
the vehicle on-board internal combustion engine is an internal combustion engine mounted on a vehicle,
the vehicle includes:
a fuel tank;
a fuel supply device;
an operation switch that switches between operation and stopping of the internal combustion engine; and
a rain sensor that detects a degree of droplet adhesion to a windshield,
the fuel supply device includes:
an electric fuel pump that delivers fuel from the fuel tank;
a fuel supply passage through which the fuel delivered by the fuel pump flows;
a fuel injection valve including a first end connected to the fuel supply passage and a second end connected to an intake passage of the internal combustion engine and provided with an injection hole, the fuel injection valve injecting fuel in the fuel supply passage from the injection hole into the intake passage; and
a seal member that seals a gap between the fuel injection valve and the intake passage, the seal member being provided in a state of being sandwiched between the fuel injection valve and the intake passage in an injection direction of the fuel injection valve; and
the control circuitry is configured to actuate the fuel pump when a logical conjunction of following conditions is satisfied:
(i) a condition in which operation of the internal combustion engine has been stopped by manipulation of the operation switch; and
(ii) a condition in which the degree of droplet adhesion detected by the rain sensor is greater than or equal to a prescribed value.

2. The controller for the vehicle on-board internal combustion engine according to claim 1, wherein the control circuitry is configured to intermittently actuate the fuel pump when the logical conjunction is satisfied.

3. The controller for the vehicle on-board internal combustion engine according to claim 1, wherein
the vehicle includes an engine compartment hood that opens and closes an upper opening of an engine compartment of the vehicle, and
the control circuitry is configured to
intermittently actuate the fuel pump when the engine compartment hood is closed in a case in which the logical conjunction is satisfied, and
continuously actuate the fuel pump when the engine compartment hood is open in a case in which the logical conjunction is satisfied.
